(19) United States
(12) Patent Application Publication
(10) Pub. No.: US 2010/0051063 A1
(43) Pub. Date: Mar. 4, 2010

(54) Ware Rinsing Apparatus

(75) Inventors: Robert C. Vroom, Kernesville, NC (US); Lucian Bibirus, High Point, NC (US)

Correspondence Address: COATS & BENNETT, PLLC, 1400 Crescent Green, Suite 300, Cary, NC, 27518, US

(73) Assignee: Champion Industries, Inc., Winston-Salem, NC (US)

(21) Appl. No.: 12/203,977

(22) Filed: Sep. 4, 2008

(51) Int. Cl. B08B 3/02; A47L 15/22

(52) U.S. Cl. 134/25.2; 134/172; 134/95.3

(57) ABSTRACT

A ware rinse and/or dishwashing device includes an enclosure with a support adapted to support a dish tray in a working chamber. A rotatable rinse arm assembly is disposed in the enclosure below the support. The rinse arm assembly has a plurality of non-linear arms disposed for rotation about a common rotational axis. Each of the arms has at least two of the nozzles mounted thereon. The nozzles are disposed so that water sprayed therefrom during a period of time of a plurality of revolutions of the rinse arms has a coverage variation of not more than 25%. The two nozzles on each arm may be an inner nozzle disposed proximate the revolution axis and an outer nozzle disposed distal therefrom.

### BACKGROUND

The present invention is generally directed to food ware cleaning devices, and more particularly to a device that rinses wares with an improved rinse water distribution technique, and related methods.

Restaurants and other food service establishments typically employ numerous devices to clean their plates, cups, glasses, utensils, and the like, collectively referred to in the art as “wares”. One common example is a dishwashing machine. While dishwashing machines are also found in household settings, commercial dishwashing equipment differs in that they are typically faster and must meet numerous additional requirements, such as those dictated by health codes. Faster cleaning allows the food service establishment to have a lower inventory of wares, which takes up less physical space and lowers operating costs. However, health codes typically require that each piece of ware be rinsed by at least a certain minimum amount of water at or above a certain temperature (such as 180° F.), with the intent being that the surfaces of the ware will therefore necessarily reach at least a certain temperature in order to kill any bacteria that may be present thereon.

Available batch-type commercial ware washing machines have approached the distribution of rinse water during the rinse process in various ways, such as stationary sprayers, rotating spray arms, etc., all of which have resulted in rather uneven distribution of the rinse water. This uneven distribution of rinse water in prior art devices has therefore caused the rinse cycle to be extended in order to ensure that each piece of ware is subjected to at least the minimum amount of hot water. However, extending the rinse cycle means more time is needed and also consumes more hot water, which results in increased water and energy use. Thus, while various approaches to ware rinsing exist, there remains a need for alternative approaches.

### SUMMARY

In one illustrative embodiment, the present invention provides a dish rinse device comprising: an enclosure with a support disposed in the enclosure and adapted to support a dish tray. A rotatable rinse arm assembly is disposed in the enclosure in spaced relation to the support. The rinse arm assembly comprises: a plurality of non-linear arms, including first, second, and third arms disposed for rotation about a common rotational axis; and a plurality of nozzles disposed on the arms so that each of the first, second, and third arms has at least two of the nozzles mounted thereon. The nozzles are disposed so that water sprayed therefrom during a period of time of a plurality of revolutions of the rinse arms has a coverage variation of not more than 25%. The arms may be disposed symmetrically, and may have not more than two nozzles mounted thereon. The nozzles on each arm may comprise an inner nozzle disposed proximate a revolution axis of the rinse arm assembly and an outer nozzle disposed distal therefrom.

In another illustrative embodiment, the present invention is a method of rinsing food service wares comprising: supporting a tray on a support disposed in an enclosure; the tray having a plurality of food service wares thereon; spraying water onto the wares from a rotating rinse arm assembly disposed below the support. The rinse arm assembly comprises a plurality of non-linear arms, including first, second, and third arms; and a plurality of nozzles disposed on the arms so that each of the first, second, and third arms has at least two of the nozzles mounted thereon. The spraying comprises rotating the rinse arms a plurality of revolutions while spraying water from the nozzles with a coverage variation of not more than 25%. The rinse arm assembly may rotate at one hundred rpm or less, and/or the period of time may be not more than thirty seconds. The spraying may comprise spraying so that a minimum of 3600 Heat Equivalent Units (HEU) per the ANSI/NSF 3 (2007) standard is applied to the wares.

The various aspects of the various embodiments may be used alone or in any combination, as is desired.

### BRIEF DESCRIPTION OF THE DRAWINGS

FIG. 1 is a perspective view of a tray with some partitions having wares therein.

FIG. 2 is a front view of a dishwashing machine according to one embodiment.

FIG. 3 is a perspective view of two rinse arm assemblies according to one embodiment, with interconnecting plumbing and also showing the location of washing arm assemblies.

FIG. 4 is a top view of the rinse arm assembly of FIG. 3 showing a spray pattern, truncated at the level of the tray, at an instant in time during a spray distribution test.

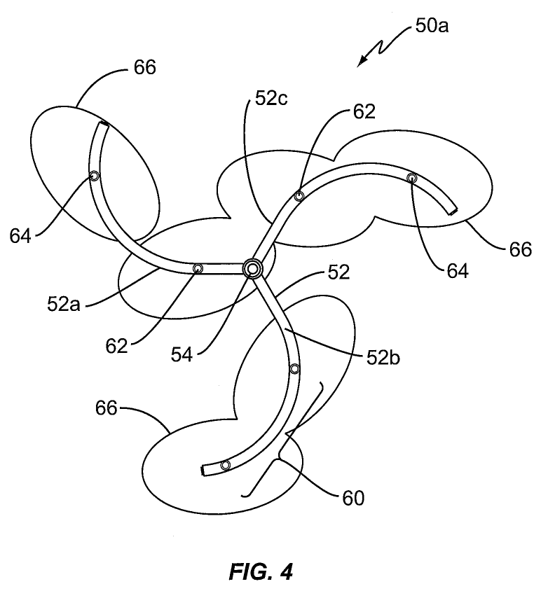

### DETAILED DESCRIPTION

The present application is directed to a batch type rinsing machine for “wares”, which are plates, cups, glasses, utensils, and the like. While the present invention may be used in a rinsing-only machine, the invention may be more advantageously be employed in a combined washing and rinsing machine for commercial applications, typically referred to as a dishwasher. As such, the following illustrative description will be in the context of a commercial batch-type dishwasher.

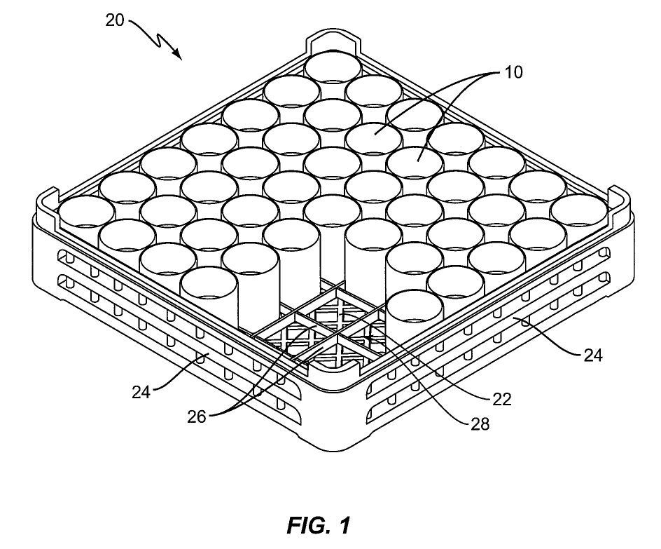

Commercial batch-type dishwashers typically clean wares 10 that are supported on a dishwashing tray 20, such as that shown in FIG. 1. The tray 20 includes sidewalls 24, a bottom 22, and optionally internal partitions 26. The peripheral sidewalls 24 typically form a rectangle, and advantageously a square. Typically, the sidewalls 24 form a twenty inch by twenty inch square. The bottom 22 joins together the sidewalls 24 and provides support to keep the wares 10 in the tray 20. The internal portion of the tray 20 may be a variety of configurations, depending on whether the tray 20 is intended to hold flatware (knives, forks, spoons), glasses, or plates. In one common configuration, partitions 26 help divide the tray 20 into a plurality of open-topped compartments 28. Typically, the compartments 28 are arranged in a regular array, with conceptual rows and columns. As is conventional, the bottom 22, sidewalls 24, and partitions 26 are advantageously not solid walls, but are instead mostly open with a plurality of openings therethrough.

The cleaning process typically includes loading the wares 10 into the tray 20 at a location external to the dishwasher and then loading the filled tray 20 into the dishwasher. A cleaning cycle is then run, with the cleaning cycle typically including a washing step and a rinsing step. In the washing step, water and detergent are sprayed onto the wares 10 to remove food particles and the like. This is typically done at relatively high spray velocities, as the resultant turbulent action helps facilitate the cleaning process. Thereafter, the cleaning water is removed, and the wares 10 are subjected to a rinse operation where clean water is sprayed on the wares 10 in order to remove any residual detergent from the wares 10. Typically, the water used in the rinse step is hot water (e.g., at or above 180° F.) so that the wares 10 are also sanitized during the rinse cycle. However, some dishwashers may use lower temperature, even ambient temperature, water to rinse after the washing step. For such machines, an additional step known as sanitizing may be employed where the wares 10 are rinsed with a sanitizer solution, typically containing iodine and/or chlorine, in order to kill any bacteria on the surface of the wares 10. For simplicity, the discussion below assumes that sanitizing occurs concurrently with the rinse step, but it should be understood that the principles of the present invention can be applied when rinsing, regardless of the temperature of the water or whether the water contains a sanitizer.

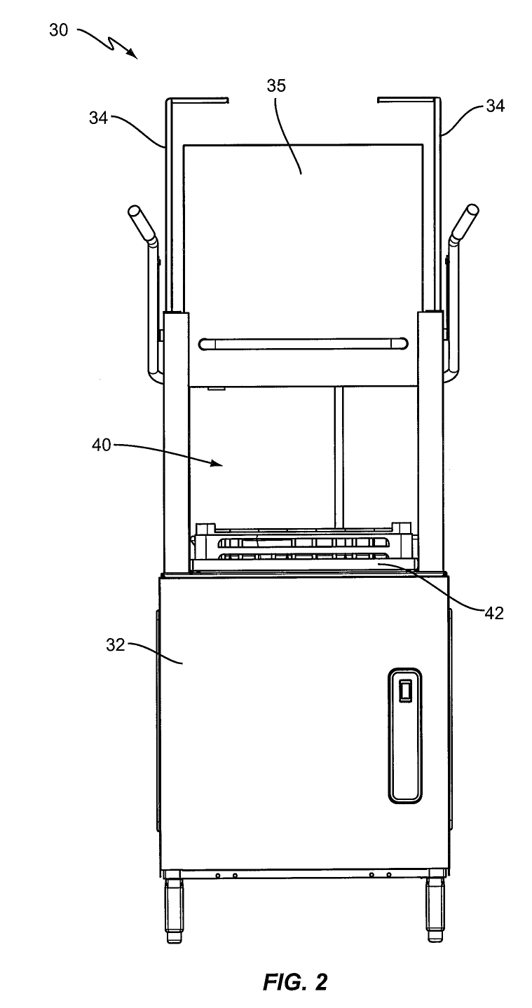

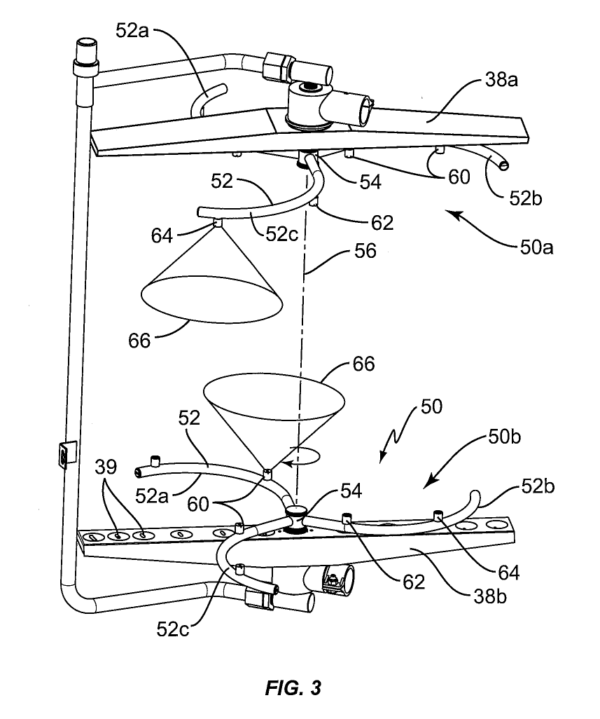

FIG. 2 shows a dishwasher, generally designated at 30. The dishwasher 30 includes a housing 32 having a working chamber 40 that is substantially enclosed by sidewalls 34 and a door 35. In some embodiments, the sidewalls 34 be moveable so as to also function as doors. Thus, both the sidewalls/doors 34 and the front door 35 may be moveable to allow access to chamber, and may be counter-balanced if desired. As is conventional, suitable support brackets 42 are provided in the intermediate portion of the chamber 40 for supporting a dishwashing tray 20, as discussed further below. The upper portion of the chamber 40 includes an upper washing arm assembly 38a and an upper rinse arm assembly 50a. The lower portion of the chamber 40 includes a lower washing arm assembly 38b, a lower rinse arm assembly 50b, and a drain. Referring to FIG. 3, the upper washing arm assembly 38a is rotatably mounted and includes one or more arms with suitable wash nozzles 39 disposed thereon and directed generally toward the center of working chamber 40. The lower washing arm assembly 38b is also rotatably mounted and includes one or more arms with suitable wash nozzles 39 disposed thereon and directed generally toward the center of working chamber 40. If desired, the washing arm assemblies 38a,38b may be substantially mirror images of each other. As is conventional, the dishwasher 30 is connected to suitable sources of clean water and power, and may include a water heater for heating in the incoming water to a desired temperature, such as 180° F. or more. Suitable controls are provided for controlling the operation of the dishwasher 30.

The upper and lower rinse arm assembles 50a,50b are advantageously substantially identical and aligned with each other. As such, the following description of the lower rinse arm assembly 50b likewise applies to the upper rinse arm assembly 50a. The lower rinse arm assembly 50b shown in FIG. 3 includes a plurality of rinse arms 52 that are mounted for rotation about a common rotational axis 56. In the illustrated embodiment, there are three rinse arms 52a,52b,52c that are disposed at approximately 120° intervals about the common center hub 54. The rinse arms 52a,52b,52c are not straight (linear), but are instead curved so as to follow a curving path, typically one that bends only one way with either a continuous or varying radius of curvature. The three arm bodies 52a,52b,52c may be advantageously disposed in a common horizontal plane, and may be identical or different from each other. Advantageously, however, each arm 52a,52b,52c has the same angular momentum so that the overall rinse arm assembly 50b is rotationally balanced. Each rinse arm 52 has corresponding spray nozzles 60 thereon that are directed generally upward. In the illustrated embodiment, each arm has two spray nozzles 60: an inner nozzle 62 and an outer nozzle 64. The inner and outer nozzles 62,64 may be identical, or may be different in type and/or size. The inner and outer nozzles 62,64 may be oriented/directed at the same or different angles relative to horizontal. For example, the outer nozzles 64 may be oriented almost directly upward, while the inner nozzles 62 may be oriented more rotationally rearward. As can be appreciated, changing the angle of the nozzles 62,64 changes the distribution pattern of the water sprayed therefrom. For example, angling the nozzles 62,64 rotationally rearward tends to increase rotational speed of the rinse arm assemblies 50a,50b while angling the nozzles 62,64 toward or away from the center of the rinse arm assembly 50a,50b (toward or away from axis 56) changes the position of the resulting spray and potentially changes the amount of overlap of the relevant spray patterns 66. The nozzles 62,64 may generate output spray patterns 66 of any appropriate shape, such as radially symmetric (e.g., conical), or somewhat conical but with an elliptical cross-section (“fan” type), or other shapes known in the art.

In one illustrative embodiment, the rinse arm assemblies 50a,50b have three rinse arms 52 that are mounted to a 1.2 inch diameter hub 54. The rinse arms 52 have an inner diameter of approximately 0.4 inches and are approximately 10.6 inches long. The rinse arms 52 are spaced 120° apart so as to be symmetric about the rotational axis 56. The rinse arms 52 extend radially straight out for about four inches, and then curve with an approximately five inch radius of curvature for an approximately 90° bend arc. The nozzles 62,64 are advantageously angled rotationally rearward slightly from vertical by approximately 5°, but are advantageously oriented so that their center of spray is about normal to a radial line running to the rotational axis 56. Nozzle 62 on arm 52a is located approximately 2.2 inches out from axis 56, while nozzle 64 is located approximately 6.9 inches out from axis 56. Nozzle 62 on arm 52a is located approximately 2.2 inches out from axis 56, while nozzle 64 is located approximately 6.9 inches out from axis 56. Nozzle 62 on arm 52b is located approximately 6.1 inches out from axis 56, while nozzle 64 is located approximately 8.3 inches out from axis 56. Nozzle 62 on arm 52c is located approximately 4.3 inches out from axis 56, while nozzle 64 is located approximately 8.0 inches out from axis 56. The nozzles 62,64 in this embodiment advantageously include a slit that forms an approximately 65° partially flattened cone shaped output, and may be referred to in the art as 65° “V” nozzles. The nozzles 62,64 are advantageously oriented so that the slits in the nozzles are angled approximately 10° rotationally rearward with respect to the radial line of the straight sections of the corresponding rinse arm 52.

As shown in FIG. 3, the rinse arm assemblies 50a,50b are advantageously disposed slightly inward of the washing arm assemblies 38a,38b so as to have more unobstructed path to the tray 20. Further, the rinse arm assemblies 50a,50b are positioned in spaced relation to the tray support 42 so that there is a space between the nozzles 60 and the tray 20 when present. This space allows the water from the spray nozzles 60, which is ejected in an expanding output pattern 66, to spread out sufficiently to properly cover the wares 10 in the tray 20. The combined output patterns 66 from all the spray nozzles 60 of a given rinse arm assembly 50a,50b should cover the entire area of the tray 20 at the level of the tray 20 during one rotation of the corresponding rinse arm assembly 50a,50b. That is, as the rinse arms 52 rotate through one revolution, the entire cross-sectional area of the tray 20 should be covered by the spray.

One method of verifying that the desired spray coverage is being achieved is to run what is referred to herein as a “spray distribution test.” To run this test, the dishwasher is connected to a water supply and a power supply in a conventional fashion. A tray is completely filled with Libby #618 eight ounce glasses, oriented so that their open ends face upward. The tray is placed in the working chamber and the door closed. The dishwasher is then run through a rinse cycle which should be long enough for multiple revolutions of the rinse arms, such as three to ten revolutions. The amount of water captured by each glass is then checked. If all the glasses have about the same amount of water in them, then the spray distribution is approximately even. If this is so, then a sanitization test may be run according to the ANSI/NSF 3 (2007) standard to adjust the cycle duration so that all the wares receive at least the minimum amount of heat to sanitize the wares (e.g., enough to provide 3600 Heat Effective Units (HEU) with 180° F. rinse water to all wares). However, if one or more of the glasses have no water in them, then there are areas uncovered by the spray, and increasing the cycle time will not improve the result, and passage of the ANSI/NSF standard cannot be achieved.

It may be that all the glasses have some water in them, but some glasses have substantially more or less than others. This is the situation with prior art dishwashers. The present dishwasher 30 addresses this by having the nozzles 60 arranged and oriented so that the coverage variation is not more than 25%, and advantageously not more than 20%. The “coverage variation” is the amount of water in the most filled glass minus the amount of water in the least filled glass, divided by the amount in the least filled glass, when tested according to the spray distribution test described above. For example, assume that the most filled glass has amount A and the least filled glass has amount B when tested as above. Then, the “coverage variation” is (A−B)/B, which can be expressed as a percentage.

It should be noted that in prior art devices the most filled glass could contain more than twice the amount of the least filled glass, meaning the coverage variation could be 100% or more. Thus, in order to ensure that the lowest filled glass met at least the minimum amount required by the health codes, the duration of the rinse cycle had to be increased, with the result being that the highest filled glass was subjected to substantially more water than required. Such a situation meant that the rinse cycle was longer, and used more hot water, than if the distribution was such that all the glasses were closer to some average value. By limiting the coverage variation to be not more than 25%, the dishwasher of the present invention helps minimize the rinse cycle time and the resultant energy use. Advantageously, the coverage variation is less than 20%, and more advantageously not more than 15%.

The discussion above has been in the context of a dishwasher 30 having both upper and lower rinse arm assemblies 50a,50b. Such is believed to be advantageous. However, in some embodiments, the dishwasher 30 may have only an upper rinse arm assembly 50a, or only a lower rinse arm assembly 50b. Further, the discussion above has assumed that the rinse arm assemblies 50a,50b have three arms; however, the rinse arms may have more than three arms if so desired. Further still, the discussion above has been in the context of a commercial batch-type dishwasher. However, as pointed out above, the present invention is not limited to such devices. Indeed, the present invention likewise finds application in all batch or cyclic type dish machines that include a rinse step.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A dish rinse device comprising:
an enclosure;
a support disposed in said enclosure and adapted to support a dish tray;
a rotatable rinse arm assembly disposed in said enclosure in spaced relation to said support; said rinse arm assembly comprising:
a plurality of non-linear arms, including first, second, and third arms disposed for rotation about a common rotational axis;
a plurality of nozzles disposed on said arms so that each of said first, second, and third arms has at least two of said nozzles mounted thereon;
wherein said nozzles are disposed so that water sprayed therefrom during a period of time of a plurality of revolutions of said rinse arms has a coverage variation of not more than 25%.

2. The dish rinse device of claim 1 wherein said arms are disposed symmetrically about a revolution axis of said rinse arm assembly.

3. The dish rinse device of claim 1 wherein each of said first, second, and third arms has not more than two nozzles mounted thereon.

4. The dish rinse device of claim 1 wherein said first, second, and third arms each have an inner nozzle disposed proximate a revolution axis of said rinse arm assembly and an outer nozzle disposed distal therefrom; wherein said inner nozzles are each of a first type and said outer nozzles are each of a second type.

5. The dish rinse device of claim 1 wherein said rinse arm assembly is an upper rinse arm assembly disposed above said support; the device further comprising a lower rinse arm assembly disposed below, and in spaced relation to, said support;
said lower rinse arm assembly comprising:
a plurality of non-linear arms, including first, second, and third arms disposed for rotation about a common rotational axis;
a plurality of nozzles disposed on said arms so that each of said first, second, and third arms has at least two of said nozzles mounted thereon;
wherein said nozzles from both said upper and lower rinse arm assemblies are disposed so that the combined water sprayed therefrom during a period of time of a plurality of revolutions of said rinse arms has a coverage variation of not more than 25%.

6. The dish rinse device of claim 5 further comprising a first plurality of washer nozzles disposed above said arms of said upper rinse arm assembly and a second plurality of washer nozzles disposed below said arms of said lower rinse arm assembly.

7. The dish rinse device of claim 5 wherein said common rotational axis of said arms of said upper rinse arm assembly and said common rotational axis of said arms of said lower rinse arm assembly are collinear.

8. The dish rinse device of claim 1 wherein said nozzles are disposed so that water sprayed therefrom during said period of time has a coverage variation of not more than 20%.

9. A method of rinsing dishes, comprising:
supporting a tray on a support disposed in an enclosure; said tray having a plurality of food service wares thereon;
spraying water onto said wares from a rotating rinse arm assembly disposed below said support; said rinse arm assembly comprising:
a plurality of non-linear arms, including first, second, and third arms;
a plurality of nozzles disposed on said arms so that each of said first, second, and third arms has at least two of said nozzles mounted thereon;
wherein said spraying comprises rotating the rinse arms a plurality of revolutions while spraying water from said nozzles with a coverage variation of not more than 25%.

10. The method of claim 9 wherein said rotating rinse arm assembly rotates at 100 rpm or less.

11. The method of claim 9 wherein said period of time is not more than 30 seconds.

12. The method of claim 9 further comprising terminating said spraying of water and thereafter removing said tray from said enclosure.

13. The method of claim 9 wherein said spraying further comprises spraying so that a minimum of 3600 Heat Equivalent Units is applied to the wares according to ANSI/NSF 3 standard, 2007 revision.

14. The method of claim 9 further comprising spraying washing solution onto said wares, prior to said spraying water onto said wares from said rotating rinse arm assembly, while said tray is disposed in said enclosure.

15. The method of claim 9 wherein said spraying water onto said wares from said rotating rinse arm assembly comprises spraying water having a temperature of about 180° F. or more from said rotating rinse arm assembly.

16. The method of claim 15 wherein said spraying further comprises spraying so that a minimum of 3600 Heat Equivalent Units is applied to the wares according to ANSI/NSF 3 standard, 2007 revision.
